(19) United States
(12) Patent Application Publication
(10) Pub. No.: US 2021/0074127 A1
(43) Pub. Date: Mar. 11, 2021

(54) SYSTEM FOR A SPORTS INFORMATION AND BETTING PLATFORM

(71) Applicant: Blake Fleck, San Rafael, CA (US)

(72) Inventor: Blake Fleck, San Rafael, CA (US)

(21) Appl. No.: 16/563,322

(22) Filed: Sep. 6, 2019

(51) Int. Cl. G07F 17/32

(52) U.S. Cl. CPC G07F 17/3288; G07F 17/3237; G07F 17/3209; G07F 17/3269

(57) ABSTRACT

A wagering system is disclosed which includes a social media system comprising a content module operable via a processor on a computing device to display a plurality of content to a plurality of users on a mobile device and a content module to display the plurality of content on the mobile device. An evaluation system evaluates a prediction history of one or more experts and assigns a value to the one or more expert predictions. The value corresponds to a payment required for the user to receive the one or more expert predictions. A wagering system permits the creation and execution of one or more wagers and a book database to store a plurality of wager parameters. The book database is in operable communication with a wager processor to receive one or more wagers from a plurality of users, and one or more accepted wager parameters.

### TECHNICAL FIELD

The embodiments generally relate to digital services, and more specifically, relate to betting services, wager services, fantasy sports games, wager predictions, sports betting predictions, and social networking.

### BACKGROUND

Sportsbooks are locations where bettors can wager on various events including baseball, football, basketball, hockey, horse racing, boxing, and various other events. The “books,” as they are known, include all the available events (e.g., sports games) for which wagers are actively available to bettors. The books also include the associated odds, betting line, or point spread associated with each event.

There is an inherent risk in betting, which requires the bettor to wager money on a predicted outcome of an event. It is common for bettors to spend a significant amount of time researching the event to make an educated prediction on the outcome to mitigate the risk of the desired wager. Many event-specific experts offer their opinions and betting advice on electronic platforms or social media to draw traffic to their webpage or content stream. Further, some experts offer a plurality of predictions which they sell to potential bettors as their expert analysis.

Currently, there are no systems that include wagering/betting, advice, general information related the particular events for which wagers may be made, social interactions between bettors and fans alike, and historical data related to expert advice.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments described herein relate to a wagering system which includes a social media system comprising a content module operable via a processor on a computing device to display a plurality of content to a plurality of users on a mobile device and a content module to display the plurality of content on the mobile device. An evaluation system analyzes the prediction history of one or more experts to assign a value to the one or more expert predictions. The value corresponds to a payment to receive the one or more expert predictions. A wagering system permits the creation and execution of one or more wagers and a book database to store a plurality of wager parameters. The book database is in operable communication with a wager processor to receive one or more wagers from a plurality of users, and one or more accepted wager parameters.

The system allows for users in the community to interact with one another via their smart or mobile computing devices. Users may interact in a social media environment or a gaming/wagering environment. Further, the system allows users to consume media related to sporting and gaming events and fantasy sports. Expert information, such as predictions are provided to the users to provide an all-in-one system.

In one aspect, the evaluation system displays, via a presentation module, an indicator on a user interface of the computing device. The indicator corresponds to a rating corresponding to the prediction history of the one or more experts.

In one aspect, the evaluation system corresponds a value to the prediction history of the one or more experts. The value corresponds to a payment required to access the one or more expert predictions.

In one aspect, the access to the one or more expert predictions is provided to the user following payment to the expert, facilitated by a compensation module.

In one aspect, the system is further comprised of a customized gaming system having a creation module to permit a user to create a customized game.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates an exemplary block diagram of the network infrastructure, according to some embodiments;

FIG. 2 illustrates a block diagram of the sports information and wagering system which includes the social media system, wagering system, fantasy sports system and customized gaming system, according to some embodiments;

FIG. 3 illustrates a block diagram of the social media system, according to some embodiments;

FIG. 4 illustrates a block diagram of the wagering system, according to some embodiments;

FIG. 5 illustrates a block diagram of the fantasy sports system, according to some embodiments;

FIG. 6 illustrates a block diagram of the customized gaming system, according to some embodiments;

FIG. 7 illustrates an exemplary user interface of the expert evaluation system, according to some embodiments; and

FIG. 8 illustrates a block diagram of the expert evaluation system, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein provide a system for sports media, social sports betting, fantasy sports, and custom sports betting games. The system allows bettors to pay for the services of sports betting experts. Each expert is given a rating based on their history of wins and losses. The expert may be allowed to charge the bettor for predictions, with fees increasing or decreasing depending on the win and loss history associated with the expert. The system will also provide the ability for users to consume media to further inform their betting decisions or for entertainment purposes, which may not necessarily be consumed by bettors but also by fans of the event. Users may also create custom sports betting games and engage in various wagers within the confines of the user-created rules. A fantasy sport betting and media platform is also provided to allow users to create fantasy sports leagues, place wagers on fantasy sports event outcomes, and communicate with other users regarding fantasy sports.

In some embodiments, the system is provided over a network to permit users to engage with the features of the system on a computing device, such as a desktop computer, laptop, smartphone, tablet, PDA, or similar devices.

In some embodiments, the system may be accessible within a gaming establishment, including, but not limited to, casino management systems, kiosks located in the gaming establishment, electronic gaming machines, portable gaming devices, or any other system that performs gaming or communication functions.

According to some embodiments, users are permitted to perform social networking functions while using the system, either remotely or in a gaming establishment. For example, users may be permitted to interact with other users or experts offering free services or services for compensation, view status information of events, or view similar systems for making wagers. Communications may also include the transmittal of offers to wager, wagers, or compensation to other users of the system.

Compensation may include sharing or trading credits, points, electronically transferred money, cash, and similar items associated with the electronic transfer of compensation utilized in the associated arts.

Games and/or events that may benefit from such social networking functions include any game offered in the gaming location including, but not limited to, games of chance, games of skill and chance, table-based games (e.g., poker, roulette, blackjack), card-based games such as video poker, video slot machines, professional or amateur sporting events, social events, among other games and events known in the arts.

In some embodiments, a communication module permits communication between one or more users in real-time or near real-time. Chat rooms may be created by users to facilitate the aggregation of information into defined categories. Users may consume the information provided in the chat room, as well as actively interact with other users. In some examples, chat rooms may filter user interaction by topic, location of the user, event, or wager characteristics.

In some embodiments, users may communicate using a private messaging system, wherein communications are only accessible between users who are pre-approved to communicate with one another.

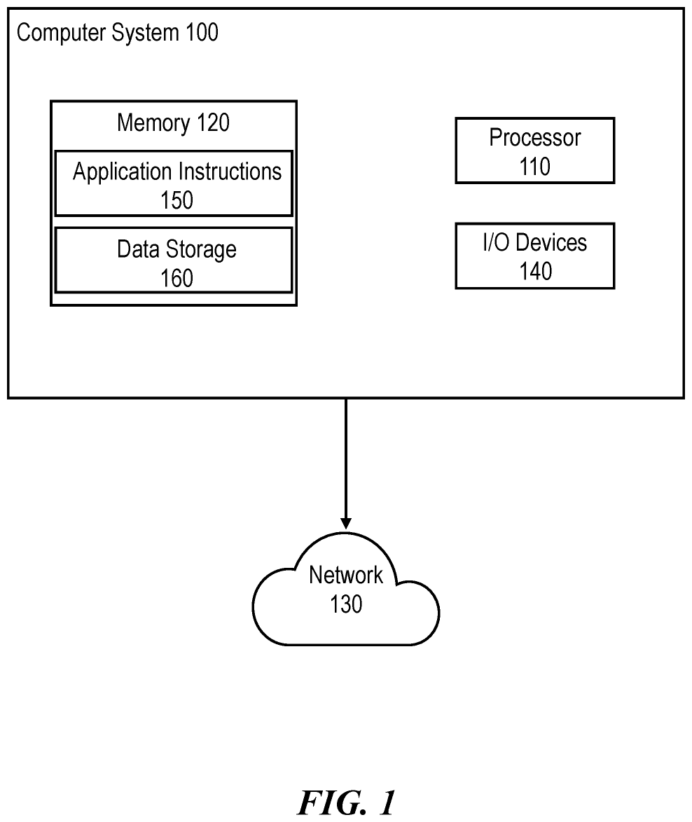

FIG. 1 illustrates a computer system 100, which may be utilized to execute the processes described herein. The computing system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example; via telecommunications/telephony networks such as analog voice networks or digital fiber communications networks; via storage area networks such as Fiber Channel SANs; or via any other suitable type of network and/or protocol.

The memory 120 may include application instructions 150, configured to implement certain embodiments described herein, and a data storage 160, comprising various data accessible by the application instructions 150. In an embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.). The data storage 160 may include data such as, for example, user profile data, event data, expert data, expert prediction history, wager parameters (such as odds), fantasy sports data, and customized gaming data. One skilled in the arts will readily understand that various data may be stored within data storage which relates to the embodiments described herein.

The steps and/or actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 100 such that the processor 100 can read information from, and write information to, the storage medium. In the alternative, the storage medium may be integrated into the processor 100. Further, in some embodiments, the processor 100 and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

Also, any connection may be associated with a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

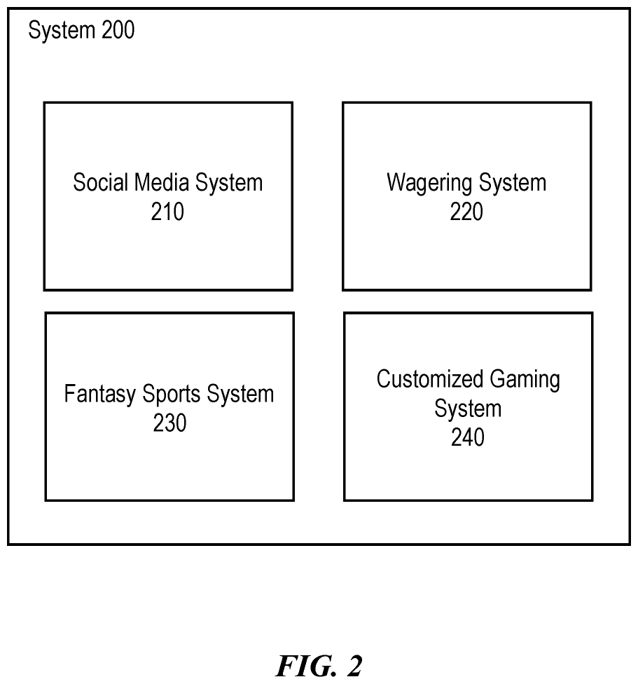

FIG. 2 illustrates a block diagram of the sports information, wagering, and social media system 200 (collectively referred to hereinafter as the “system”) according to an exemplary embodiment. The system 200 is comprised of a social media system 210, a wagering system 220, a fantasy sports system 230, and a customized gaming system 240. The social media system 210 provides a platform on a user interface of a computing device wherein users may interact with one another, share information, consume information from other users, administrators, sports teams, event experts, and other users of the system 200. The wagering system 220 permits the creation and execution of wagers by users within the system 200. The fantasy sports system 230 allows the user to engage in fantasy sports activities, including creating a fantasy sports league, team, player, or similar entity. Further, the user may wager on fantasy sports via the wagering system 220. The fantasy sports system 230 may also include other capabilities associated with the fantasy sports arts including communications, and customization of fantasy sports rules. The customized gaming system 240 allows users to create customized games which may be wagered on via the wagering system 220. For example, the customized gaming system 240 may permit the user to create a custom wager scheme for a plurality sporting and/or gaming events.

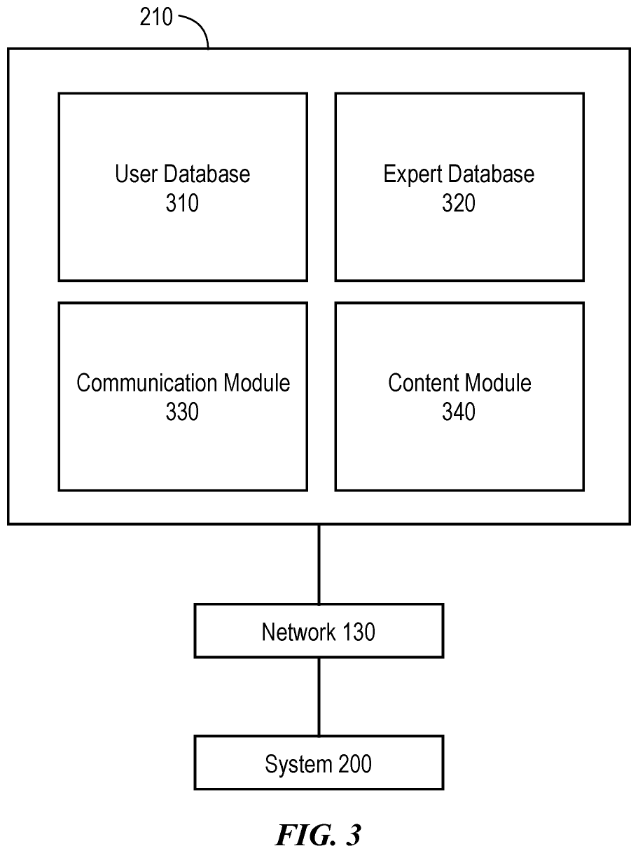

FIG. 3 illustrates an exemplary social media system 210 provided by the system 200 via network 130. The social media system 210 is comprised of a user database 310 including the user profiles and user information associated with each profile. An expert database 320 is comprised of expert profiles and information associated with the expert profile. The expert database 320 may also store historical data associated with the expert, such as wins and losses for predictions provided by the expert, and the maximum amount the expert may charge for services. A communication module 330 permits users and experts alike to communicate with one another. Content is generated by the content module 340 including event information, user profile information, expert profile information, and general information provided via message board or blog post created by users, experts, or administrators of the system.

The user may be provided with, data and/or information, including, but not limited to, analytics data and/or information, information regarding betting odds changes, information regarding new betting opportunities, any other data and/or information, regarding any other sporting event(s), game(s), match(es), activity or activities, competition(s), or tournament(s), or any team(s) and/or player(s) or participant(s) in same, in which the user may be interested.

In some embodiments, the content module displays expert information generated by the expert, such as expert predictions for a particular event. For example, the expert may input a prediction for an event outcome (such as a soccer game between two teams wherein one team wins by 3 goals). In another example, the user may post a message to the community of users commenting on an upcoming event.

In an alternate embodiment, the leader board may provide an indicator associated with a particular expert that identifies the prediction history of the expert. The characteristics may include but are not limited to how successful the expert has been over a predetermined time period, how unsuccessful the expert has been over a predetermined time period, a status identifying the experts standing in their respective league, availability of the expert to make predictions, data identifying the number of additional experts have used information from the particular experts, data identifying total amount of monies won using information provided by the expert, and additional information known in the arts. These characteristic indicators are presented to users across the entire system and allow the users to determine if at least one particular expert may be able to provide helpful information for future wagers. A user-selectable icon may be associated with the experts having a particular characteristic indicator showing that allows user to contact the particular expert to obtain information therefrom. By selecting the icon, the user is required to pay a fee to at least one of the particular experts to have access to the particular experts information

In some embodiments, the social media system 210 facilitates communication between users (peer-to-peer communication) and communication between users and experts. Communication between users may include facilitating users engaging in a wager, engaging in a fantasy sports league, on a blog, or an aggregated display of information on the social media user interface.

In some embodiments, the social media system 210 may permit the user to set up wagering games, or a wager on events against other users or administrators of the system 200 via the wagering system 220. Community-type wagering schemes may benefit from employing the social media system 210.

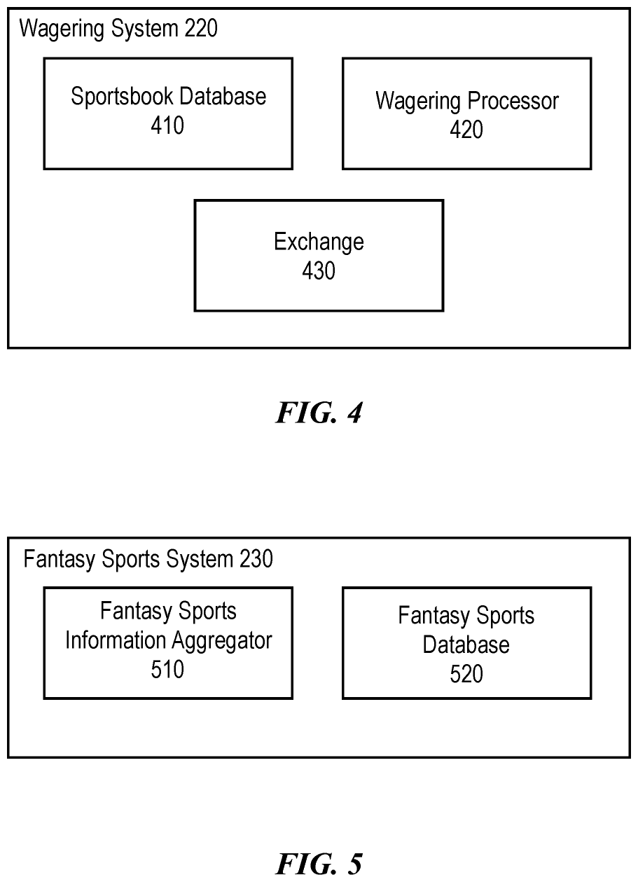

FIG. 4 illustrates an exemplary wagering system 220, wherein users can conduct wagering activities including selecting a wager, customizing wager parameters, sending wager requests to other users, and accepting and denying wagers received from other users. The wagering system 220 may be comprised of a sportsbook database 410 which receives inputs from a bookmaker who establishes the available events upon which wagers may be made, as well as the wager parameters (such as odds) associated with various wagers. A wagering processor 420 permits users to execute wagers with one another and transfer funds via an exchange 430.

The user can place a bet on the selected sporting event, game, match, activity, competition, or tournament, and the individual or user can utilize a payment identifier, such as his or her sports betting account number, gaming account number, or gambling account number, in order to place and make payment for the bet. The user can also provide a payment identifier such as, but not limited to, a credit account number, a credit card account number, a debit account number, a debit card account number, a charge account number, a charge card account number, a savings account number, a checking account number, or any other payment account number.

FIG. 5 illustrates an exemplary fantasy sports system 230 provided by the system 200. A fantasy sports information aggregator 510 provides a plurality of content related to fantasy sports. The fantasy sports database 520 stores information related to user fantasy sports profiles, statistics, fantasy sports rules, and wagers placed on various fantasy sports activities. The fantasy sports gaming system 230 provides for the first long-term, multi-platform, short segment, competition among professional handicappers and amateur handicappers, where they compete as to whose predictions are more accurate.

An example of how the data may be presented to the user is in the form of a leader board which that will showcase a rank for each user in the game thereby making it easy for the other users in any community who are the best and most successful users. The leader board may be categorized to show the best users based on the type of bet selected from all available types of wagers. Another user control or feature comprises being able to place a single wager and applying it to multiple events or leagues. The leader board may also provide for compiling and providing to a user a comprehensive view of a particular user's betting statistics such as winning percentage on specific bet types, total earnings year-to-date and being able to track this information year over year and across multiple events or leagues. Similarly, a leaderboard may be generated for experts who provide predictions for various events.

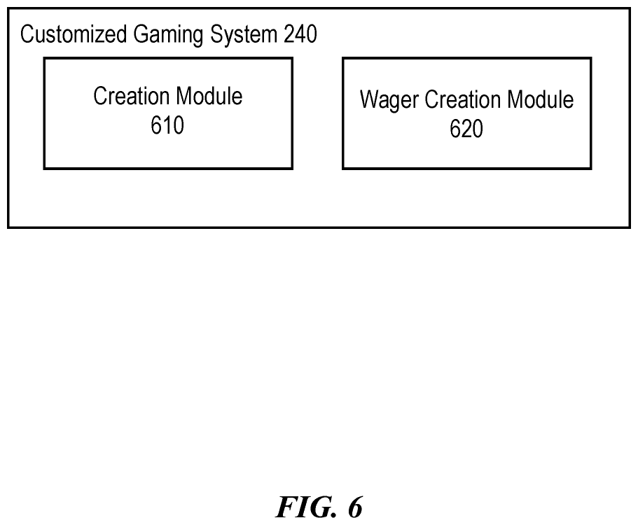

FIG. 6 illustrates an exemplary customized gaming system 240 wherein users are able to create their games, which may be wagered on by other users in the community. For example, a creation module 610 permits the user to establish one or more game parameters for an event. The wager creation module 620 permits the user to establish wager parameters including odds, events, wager types, among other parameters known in the arts.

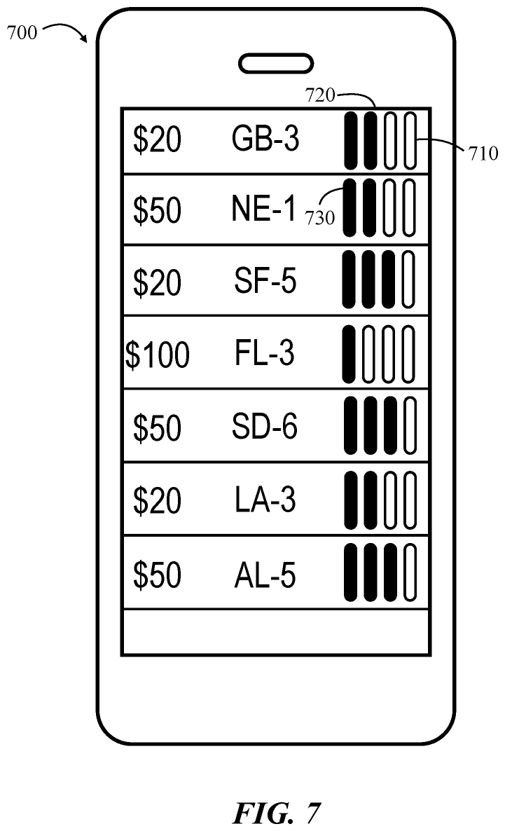

FIG. 7 illustrates an exemplary user interface for an evaluation system 700, which displays a rating 710 related to a prediction history 720 of an expert. The expert may be a user of the system 200 who sells a prediction for an event or series of events. The expert may also be a public figure, sports commentator, or likewise expert in one or more sports or gaming industries. The prediction history 720 may be comprised of a plurality of indicators 730, which indicate the success of the expert's previous predictions. For example, the indicators may include color (such as via a key-associated indicator) to indicate a favorable prediction history (e.g., using the color green for positive and red for negative). The predictions history 720 permits the expert to charge a compensation value based on the outcomes of previous advice. For example, an expert who has produced favorable predictions for each of their last 10 possible opportunities may be allowed to charge a higher compensation value for their future predictions.

In some embodiments, the prediction history is presented, via the indicators, as a predetermined success rate of the expert, wherein the success rate is calculated by the total number of successful (or favorable) prediction outcomes divided by the total amount of predictions made by the expert. For example, an expert has predicted the outcome of ten basketball games, seven of which were predicted correctly resulting in a seventy percent success rate which is displayed to the user. The seventy percent success rate corresponds to a value which the user must pay to receive future predictions from the expert. For example, a seventy percent success rate may require a $20 payment by the user, while a fifty percent success rate may only require a $10 payment from the user.

In some embodiments, the prediction history of the expert may be calculated in various ways, such as calculating an average of favorable outcomes as a function of the total number of opportunities, as a cumulative total of favorable outcomes, as a historical log of each decision, or by other means.

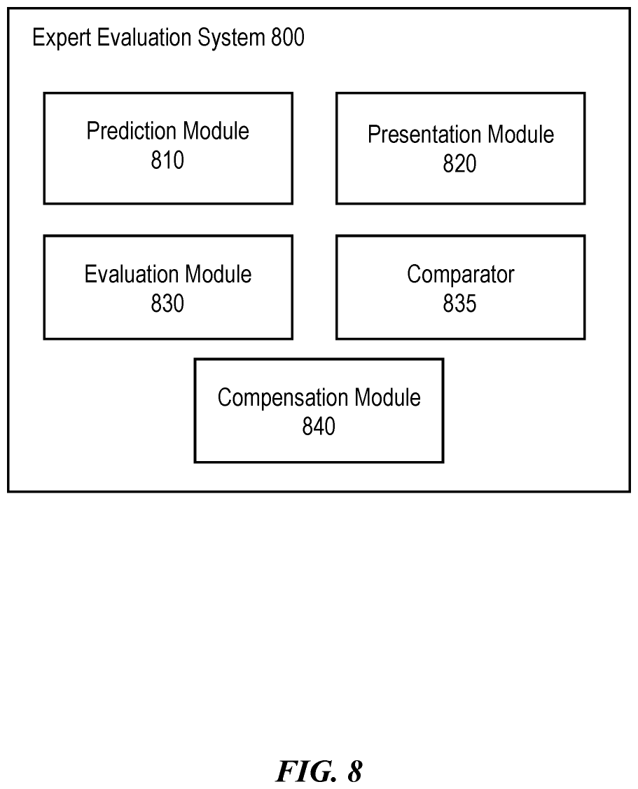

FIG. 8 illustrates a block diagram of the expert evaluation system 800, which includes a prediction module 810, a presentation module 820, an evaluation module 830, and a compensation module 840. The prediction module 810 permits the expert to input a prediction for one or more events, such as a prediction for the outcome of a baseball game. A presentation module 820 presents various information related to the expert, including the expert's prediction(s). An evaluation module 830 evaluates the prediction history of the expert, via a comparator 835 to compare the prediction made by the expert to the outcome of the event. The evaluations module 830 assigns a value to the expert's predictions which may be purchased by the user. The value is dependent on the prediction history of the expert. A compensation module 840 facilitates payment between the user who is buying the prediction made by the expert. In some embodiments, payment may be made using credits or points within the system. The credits or points may be converted into a monetary value and transferred to a financial institution. The use of credit or points ensures that payment is received which may include payment for a wager or payment to an expert for an expert prediction.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A wagering system, comprising:
a social media system comprising a content module operable via a processor on a computing device to display a plurality of content to a plurality of users on the computing device, and a content module to display the plurality of content on the computing device, the content module displaying one or more expert predictions provided by one or more experts;
an evaluation system to evaluate a prediction history of the one or more experts and to assign a value to the one or more expert predictions, the value corresponding to a payment to receive the one or more expert predictions;
a wagering system to permit creation and execution of one or more wagers and a book database to store a plurality of wager parameters, the book database in operable communication with a wager processor to receive one or more wagers from a plurality of users and one or more accepted wager parameters.

2. The system of claim 1, wherein the evaluation system displays, via a presentation module, an indicator on a user interface on the computing device, wherein the indicator corresponds to a rating corresponding to the prediction history of the one or more experts.

3. The system of claim 2, wherein the evaluation system assigns a value to the prediction history of the one or more experts, wherein the value corresponds to a payment required to access the one or more expert predictions.

4. The system of claim 3, wherein the access to the one or more expert predictions is provided to the user following the payment.

5. The system of claim 1, further comprising a customized gaming system including a creation module to permit a user to create a customized game.

6. The system of claim 5, wherein the creation module permits the user to input a plurality of rules, wherein the wager processor is configured to receive one or more wagers from the user.

7. A wagering system, comprising:
a user interface provided on a computing device to display a plurality of content related to a social media system, an evaluation system, a wagering system, and a customized gaming system, the social media system comprised of a content module operable via a processor on the computing device to display a plurality of content to a plurality of users and a content module to display the plurality of content on the computing device, the evaluation system evaluates a prediction history of one or more experts and to assigns a value to the one or more expert predictions, the value corresponding to a payment to permit a user to receive the one or more expert predictions, and a wagering system to permit creation and execution of one or more wagers;
a book database to store a plurality of wager parameters, the book database in operable communication with a wager processor to receive one or more wagers from a plurality of users and one or more accepted wager parameters;
a payment processor in operable communication with the wager processor to process a payment associated with the one or more accepted wagers.

8. The system of claim 7, wherein the evaluation system displays, via a presentation module, an indicator on a user interface of the computing device, wherein the indicator assigns a rating corresponding to the prediction history of the one or more experts.

9. The system of claim 8, wherein the evaluation system assigns a value to the prediction history of the one or more experts, wherein an assigned value corresponds to a pre-determined success rating of the expert.

10. The system of claim 9, wherein the access to the one or more expert predictions is permitted for the user following the payment.

11. The system of claim 7, further comprising a customized gaming system including a creation module to enable a user to create a customized game.

12. The system of claim 11, wherein the creation module allows the user to input a plurality of rules, wherein the wager processor is configured to receive one or more wagers from the user.

13. A system for facilitating information exchange and payment associated to wagers, the system comprising:
a user interface provided on a computing device to display a plurality of content related to a social media system, an evaluation system, a wagering system, and a customized gaming system, the social media system comprised of a content module operable via a processor on the computing device to display a plurality of content to a plurality of users on a mobile device and a content module to display the plurality of content on the computing device, the evaluation system evaluates a prediction history of one or more experts and to assign a value to the one or more expert predictions, the value corresponding to a payment to permit a user to receive the one or more expert predictions, a wagering system to permit creation and execution of one or more wagers each corresponding to a value, and a customized gaming system comprised of a creation module to enable a user to create a customized game;
a book database to store a plurality of wager parameters, the book database in operable communication with a wager processor to receive one or more wagers from a plurality of users and one or more accepted wager parameters, the book database transmitting a plurality of odds associated with a wager event;
a payment processor in operable communication with the wager processor to process a payment associated with the one or more accepted wagers.

14. The system of claim 13, wherein the evaluation system displays, via a presentation module, an indicator on a user interface of the computing device, wherein the indicator assigns a rating corresponding to the prediction history of the one or more experts.

15. The system of claim 14, wherein the indicator is comprised of one or more input fields, wherein each of the one or more input fields are populated with a key-associated indicator to display, via the user interface on the computing device, the evaluation of the prediction history of the one or more expert predictions.

16. The system of claim 15, wherein the user interface displays the payment required to access the value assigned to the one or more expert predictions.

17. The system of claim 16, wherein a ranking module ranks the one or more experts and displays the rank of the one or more experts on the user interface.

18. The system of claim 13, further comprising a fantasy sports system provided on the user interface of the computing device.

19. The system of claim 18, wherein the fantasy sports system is in communication with the social media system, the evaluation system, and the wagering system.

20. The system of claim 13, wherein the evaluation system is comprised of a comparator to compare the expert prediction to an outcome for an event associated with the expert prediction.
